(19) United States
(12) Patent Application Publication
(10) Pub. No.: US 2026/0126837 A1
(43) Pub. Date: May 7, 2026

(54) EARLY DETECTION AND MANAGEMENT OF THERMAL RISK FOR INFORMATION HANDLING SYSTEMS

(71) Applicant: Dell Products L.P., Round Rock, TX (US)

(72) Inventors: Min Thu AUNG, Singapore (SG); Chai Im TEOH, Singapore (SG); Young Hwan JANG, Singapore (SG)

(73) Assignee: Dell Products L.P., Round Rock, TX (US)

(21) Appl. No.: 18/934,280

(22) Filed: Nov. 1, 2024

(51) Int. Cl. G06F 1/20

(52) U.S. Cl. CPC G06F 1/206

(57) ABSTRACT

A disclosed thermal management method monitors a temperature of a component. Upon detecting a temperature lower than a pre-throttling temperature (PTT), the component is operated without thermal management constraints. Upon detecting a temperature exceeding the PTT, the component is operated with a pre-throttling constraint to reduce component power consumption without constraining a throttling parameter (e.g., clock speed, inserted time delay). Upon detecting a component temperature exceeding a first thermal management temperature (TMT1), performing first stage throttling is performed to limit the throttling parameter to a first stage value. The method may respond to detecting a component temperature exceeding a second TMT (TMT2) by performing second stage throttling to constrain the throttling parameter to a second stage value. The component may be a PCIe nonvolatile memory (NVM) and the pre-throttling constraint may reduce the PCIe link speed from a PCIe Gen5 value to a PCIe Gen4 or Gen3 value.

### TECHNICAL FIELD

The present disclosure is in the field of information handling systems and, more specifically, thermal management of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Semiconductors and other materials used for information handling system components generate thermal energy, i.e., heat, during operation. Heat is generally detrimental to system performance and, if not properly managed and dissipated, can result in component or system failures.

The use of high performance, high power components including, as a representative example, Peripheral Component Interconnect Express (PCIe) fifth generation (Gen5) SSDs in information handling systems, while offering significant performance benefits, introduces potential thermal risks due to the comparatively high power consumption and the corresponding comparatively high generation of thermal energy.

Controlled testing between Gen4 and Gen5 SSDs using a storage benchmark have recorded a maximum temperature of roughly 58 C for Gen5 SSD devices versus 43 C for Gen4 despite the use of a larger heatsink to prevent the Gen5 device from triggering thermal shutdown.

### SUMMARY

Thermal management challenges presented by high performance components such as Gen5 SSDs are addressed by thermal management methods and systems disclosed herein. In at least one aspect, a disclosed thermal management method monitors a temperature of a component. Upon detecting a temperature lower than a pre-throttling temperature (PTT), the component is operated without thermal management constraints including constraints on a link speed of a PCIe or another suitable type of serial data bus, a component clock frequency, and a minimum inserted time delay. Upon detecting a temperature exceeding the PTT, the component is operated with a pre-throttling constraint to reduce component power consumption without constraining a throttling parameter (e.g., component clock frequency, minimum inserted time delay). Upon detecting a component temperature exceeding a first thermal management temperature (TMT1), performing first stage throttling is performed to limit the throttling parameter to a first stage value. The method may respond to detecting a component temperature exceeding a second TMT (TMT2) by performing second stage throttling to constrain the throttling parameter to a second stage value. The component may be a PCIe solid state drive (SSD) or other type of nonvolatile memory (NVM) and the pre-throttling constraint may reduce the PCIe link speed of the SSD or other NVM from a PCIe Gen5 value to a PCIe Gen4 or Gen3 value.

In at least one embodiment, representative values for the PTT may be in a range between 73 C and 79 C, representative values for the TMT1 may be in a range between 79 C and 83 C, and representative values for the TMT2 may be in the range between 81 and 85 C. In at least one embodiment, a PTT value of 76 C, a TMT1 value of 81 C and a TMT2 values of 83 C may be used, at least initially, and the values may be modified time to time based on historical data.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a flow diagram of a representative thermal management method including early detection of thermal risk and pre-throttling thermal management in response to early detection of thermal risk;

FIG. 2 illustrates a flow diagram of a second thermal management method; and

FIG. 3 illustrates an information handling system suitable for implementing thermal management methods of FIGS. 1 and 2.

### DETAILED DESCRIPTION

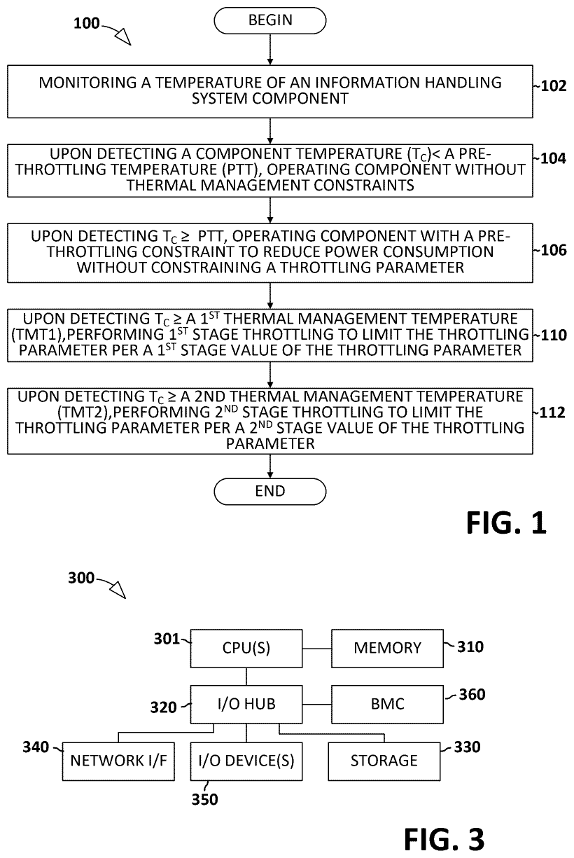

Exemplary embodiments and their advantages are best understood by reference to FIG. 1-N, wherein like numbers are used to indicate like and corresponding parts unless expressly indicated otherwise.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”), microcontroller, or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

Additionally, an information handling system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in an information handling system component used to perform predefined tasks. Firmware is commonly stored in non-volatile memory, or memory that does not lose stored data upon the loss of power. In certain embodiments, firmware associated with an information handling system component is stored in non-volatile memory that is accessible to one or more information handling system components. In the same or alternative embodiments, firmware associated with an information handling system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, as applicable, whether connected indirectly or directly, with or without intervening elements.

Turning now to drawings, FIG. 1 is a flow diagram depiction of a representative thermal management method 100. The thermal management method 100 depicted in FIG. 1 includes monitoring (102) a temperature of an information handling system component and, responsive to detecting (104) a component temperature less than a pre-throttling temperature (PTT), operating the component without thermal management constraints.

Responsive to detecting (106) a component temperature greater than or equal to the PTT, the method 100 of FIG. 1 operates the component with a pre-throttling constraint (e.g., reducing link speed of a PCIe bus) to reduce power consumption of the component without constraining a throttling parameter. Responsive to detecting (110) a component temperature greater than or equal to a first thermal management temperature (TMT1), performing first stage throttling to limit the throttling parameter in accordance with a first stage value for the throttling parameter. Responsive to detecting (112) a component temperature greater than or equal to a second thermal management temperature (TMT1), method 100 includes performing 1^{st} stage throttling to limit the throttling parameter in accordance with a second stage value for the throttling parameter.

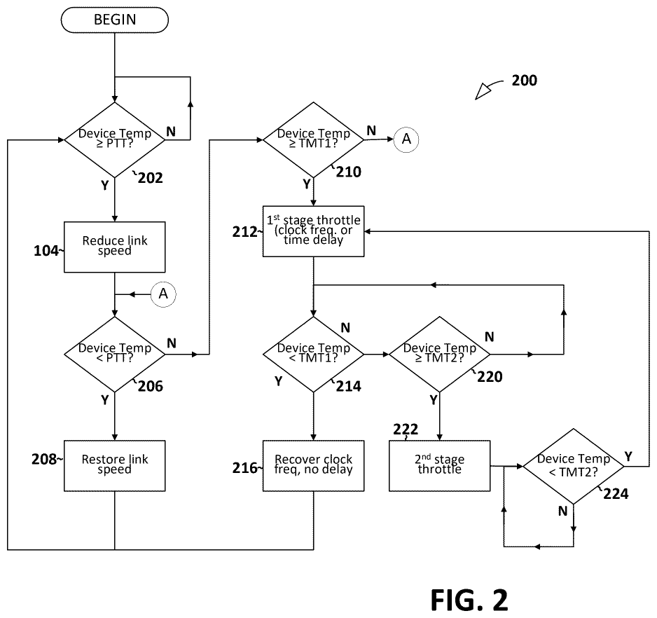

Turning now to FIG. 2, a flow diagram depiction of a thermal management method 200 is depicted. The thermal management method 200 depicted in FIG. 2 includes pre-throttling thermal management (steps 202 through 208) to take early detection action to manage thermal generation. The method 200 of FIG. 2 begins with a comparison (202) of a device temperature and the PTT. While the device temperature remains below the PTT, method 200 loops and continues to monitor the device temperature against the PTT. Upon detecting the device temperature greater than PTT, method 200 branches to operation 204 where a pre-throttling thermal management step is performed. In at least one embodiment, the pre-throttling action reduces (204) a link speed of a communication bus associated with the component. For example, a PCI device communicates with a PCIe bus and, in this case, reduction of the link speed may refer to a reduction of the PCIe link speed. In at least some embodiments, the link speed reduction may include a reduction from a higher version of the PCI standard to a lower and slower version. For example, the transition may transition the PCIe link speed from a Gen5 value to a value of an earlier generation, such as a Gen3 value or a Gen4 value.

After reducing the link speed in step 204, the device temperature is monitored (206) against the PTT. If the device temperature is less than PTT, the illustrated method branches to step 208, where the restoration of the device's speed occurs.

If the device temperature monitored in operation 206 is greater than or equal to the PTT, the illustrated method 200 branches to a throttling sequence that begins (operation 210) with a comparison of the device temperature and a first TMT value (TMT1). If the device temperature is less than TMT1 one, the illustrated method 200 branches back to the pre throttling steps, where a comparison is made against the lower value of device temperature. If the device temperature exceeds TMT1, the illustrated method branches to operation 212, where a first stage throttling is performed. As depicted in FIG. 2, the first stage throttling refers to a manipulation of a throttling parameter where, for purposes of this disclosure, the throttling parameters include the device clock, frequency, or the insertion of a time delay between adjacent instructions.

After establishing the first stage throttling, method 200 proceeds to compare the device temperature with TMT1. If the device temperature is less than TMT1, the illustrated method branches to operation 216 where the device clock frequency is restored and or any inserted time delay is eliminated. If the device temperature exceeds TMT1 in operation 214, method 200 branches to operation 220 wear a comparison of device temperature against a second thermal management temperature [TMT2) is performed. If the device temperature is greater than TMT2, method 200 branches to operation 222 where second stage and more aggressive throttling conditions are applied, for example, there may be a further reduction of the device frequency or insertion of an increasing delay.

As depicted in FIG. 2, method 200, after establishing second stage throttling conditions in operation 222, branches to operation 224, for comparing the device temperature against the second TMT. If the device temperature has cooled to the point where it is less than TMT2, method 200 branches to operation 212 where first stage throttling conditions are applied. If, in operation 224, the temperature is greater equal to TMT2, the illustrated method 200 branches back to its input and, in this manner, monitors the device temperature during second stage throttling.

Referring now to FIG. 3, any one or more of the elements illustrated in FIG. 1 through FIG. 2 may be implemented as or within an information handling system exemplified by the information handling system 300 illustrated in FIG. 3. The illustrated information handling system includes one or more general purpose processors or central processing units (CPUs) 301 communicatively coupled to a memory resource 310 and to an input/output hub 320 to which various I/O resources and/or components are communicatively coupled. The I/O resources explicitly depicted in FIG. 3 include a network interface 340, commonly referred to as a NIC (network interface card), storage resources 330, and additional I/O devices, components, or resources 350 including as non-limiting examples, keyboards, mice, displays, printers, speakers, microphones, etc. The illustrated information handling system 300 includes a baseboard management controller (BMC) 360 providing, among other features and services, an out-of-band management resource which may be coupled to a management server (not depicted). In at least some embodiments, BMC 360 may manage information handling system 300 even when information handling system 300 is powered off or powered to a standby state. BMC 360 may include a processor, memory, an out-of-band network interface separate from and physically isolated from an in-band network interface of information handling system 300, and/or other embedded information handling resources. In certain embodiments, BMC 360 may include or may be an integral part of a remote access controller (e.g., a Dell Remote Access Controller or Integrated Dell Remote Access Controller) or a chassis management controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A thermal management method, comprising:
monitoring a temperature of an information handling system component;
responsive to detecting a component temperature less than a pre-throttling temperature (PTT), operating the component without thermal management constraints;
responsive to detecting a component temperature greater than or equal to the PTT, operating the component with a pre-throttling constraint to reduce power consumption of the component without constraining a throttling parameter; and
responsive to detecting a component temperature greater than or equal to a first thermal management temperature (TMT1), performing first stage throttling to limit the throttling parameter in accordance with a first stage value for the throttling parameter.

2. The method of claim 1, further comprising:
responsive to detecting a component temperature greater than or equal to a second TMT (TMT2), performing second stage throttling to constrain the performance throttling parameter in accordance with a second stage value for the throttling parameter.

3. The method of claim 2, wherein the TMT1 is in the range of 73 C to 79 C, the TMT1 is in the range of 79 C to 83 C, and the TMT2 is in the range of 81 to 85 C.

4. The method of claim 2, wherein the PTT is less than the TMT1 and the TMT1 is less than the TMT2.

5. The method of claim 1, wherein the throttling parameter is selected from: component clock frequency and minimum inserted time delay.

6. The method of claim 1, wherein the pre-throttling constraint comprises a constraint on a link speed for a communication link over which the component communicates with another component of the information handling system.

7. The method of claim 6, wherein the communication link comprises a peripheral component interface express (PCIe) communication link.

8. The method of claim 6, wherein the component comprises a PCIe solid state drive (SSD).

9. The method of claim 1, wherein the component comprises peripheral communication interface express (PCIe) component communicatively coupled to a central processing unit (CPU) of the information handling system via a PCIe bus.

10. The method of claim 9, wherein the thermal management constraint includes a constraint on a parameter selected from: a link speed of the PCIe bus, a clock speed of the PCIe component, and a minimum inserted time delay.

11. An information handling system, comprising:
a central processing unit (CPU);
a system memory, accessible to the CPU, including processor executable instructions that, when executed by the CPU, cause the system to perform thermal management operations, including:
monitoring a temperature of an information handling system component;
responsive to detecting a component temperature less than a pre-throttling temperature (PTT), operating the component without thermal management constraints;
responsive to detecting a component temperature greater than or equal to the PTT, operating the component with a pre-throttling constraint to reduce power consumption of the component without constraining a throttling parameter; and
responsive to detecting a component temperature greater than or equal to a first thermal management temperature (TMT1), performing first stage throttling to limit the throttling parameter in accordance with a first stage value for the throttling parameter.

12. The information handling system of claim 11, wherein the thermal management operations further include:
responsive to detecting a component temperature greater than or equal to a second TMT (TMT2), performing second stage throttling to constrain the performance throttling parameter in accordance with a second stage value for the throttling parameter.

13. The information handling system of claim 12, wherein the TMT1 is in the range of 73 C to 79 C, the TMT1 is in the range of 79 C to 83 C, and the TMT2 is in the range of 81 to 85 C.

14. The information handling system of claim 12, wherein the PTT is less than the TMT1 and the TMT1 is less than the TMT2.

15. The information handling system of claim 11, wherein the throttling parameter is selected from: component clock frequency and minimum inserted time delay.

16. The information handling system of claim 11, wherein the pre-throttling constraint comprises a constraint on a link speed for a communication link over which the component communicates with another component of the information handling system.

17. The information handling system of claim 16, wherein the communication link comprises a peripheral component interface express (PCIe) communication link.

18. The information handling system of claim 16, wherein the component comprises a PCIe solid state drive (SSD).

19. The information handling system of claim 11, wherein the component comprises peripheral communication interface express (PCIe) component communicatively coupled to a central processing unit (CPU) of the information handling system via a PCIe bus.

20. The information handling system of claim 19, wherein the thermal management constraint includes a constraint on a parameter selected from: a link speed of the PCIe bus, a clock speed of the PCIe component, and a minimum inserted time delay.
